(19) United States
(12) Patent Application Publication
(10) Pub. No.: US 2008/0042472 A1
(43) Pub. Date: Feb. 21, 2008

(54) Transformer Seat

(75) Inventors: Carl J. Holdampf, Farmington Hills, MI (US); Arnold James Wickham, Brighton, MI (US); Christopher Scott Welch, Pontiac, MI (US)

Correspondence Address: CLARK HILL, P.C., 500 WOODWARD AVENUE, SUITE 3500, DETROIT, MI, 48226, US

(73) Assignee: Intier Automotive Inc., Newmarket, ON (CA)

(21) Appl. No.: 11/659,628

(22) PCT Filed: Aug. 11, 2005
(86) PCT No.: PCT/CA05/01235

§ 371 Date: Feb. 7, 2007

Related U.S. Application Data
(60) Provisional application No. 60/601,093, filed on Aug. 12, 2004.

(51) Int. Cl. B60N 2/30; B60N 2/20; B60N 2/68

(52) U.S. Cl. 297/15

(57) ABSTRACT

A seat assembly supports an occupant above a floor having a load floor and is stowable within a recess below the floor. The seat assembly includes a seat cushion extending between a seating surface and a bottom surface. A seat back is pivotally coupled to the seat cushion for movement between a seating position and a forwardly folded dump position overlying the seat cushion. A riser mechanism extends between the bottom surface of the seat cushion and the recess for allowing selective movement of the seat assembly between a seating position to support the occupant above the floor and a stowed position disposed within the recess in the floor. The riser mechanism includes a pair of front legs having a lower end pivotally coupled to the recess within the floor and an upper end pivotally coupled to the seat cushion, and a pair of rear legs having a lower end pivotally coupled to the recess within the floor and an upper end pivotally coupled to the seat cushion. A first locking strut extends between each of the front legs and the recess within the floor. First and second release handles independently unlock the locking struts to allow the riser mechanism to pivot the seat assembly from the seating position to the stowed position within the recess in the floor.

### FIELD OF THE INVENTION

The present invention relates to a seat assembly for an automotive vehicle. More particularly, the invention relates to a riser mechanism for providing movement of the seat assembly between a seating position and a stowed position.

### DESCRIPTION OF THE RELATED ART

Automotive vehicles include seat assemblies for supporting occupants within the vehicle. Seat assemblies include a seat cushion and a seat back operatively coupled to the seat cushion by a recliner mechanism for allowing selective pivotal adjustment of the seat back relative to the seat cushion between a plurality of reclined seating positions. Typically, the seat back is also movable between any one of the reclined seating positions and a generally horizontal, forwardly stowed position to present a load floor surface on the back of the seat back.

It is known in the automotive seating art to mount a four bar linkage between the seat cushion and the floor of the vehicle for moving the seat assembly between a seating position with the seat cushion spaced above the floor of the vehicle and a forwardly stowed position with the seat cushion disposed generally forward of the seating position and lying against the floor of the vehicle. The four bar linkage, as currently practiced in the seating art, requires additional packaging space forward of the seat assembly. It remains desirable to have the seat assembly selectively recline between various seating position and optionally fold to the stowed position such that the load floor surface is generally planar with the cargo floor behind the seat assembly, or alternatively, with a load floor surface of a rear seat assembly similarly positioned.

### SUMMARY OF THE INVENTION

According to one aspect of the invention, a seat assembly supports an occupant above a floor of a vehicle and is stowable within a recess below the floor. The seat assembly includes a seat cushion extending between a top seating surface and a bottom surface. A seat back is pivotally coupled to the seat cushion for movement between a seating position and a forwardly folded dump position overlying the seat cushion. A riser mechanism extends between the bottom surface of the seat cushion and the recess for allowing selective movement of the seat assembly between a seating position to support the occupant above the floor and a stowed position disposed within the recess in the floor. The riser mechanism includes a pair of front legs having a lower end pivotally coupled to the recess within the floor and an upper end pivotally coupled to the seat cushion, and a pair of rear legs having a lower end pivotally coupled to the recess within the floor and an upper end pivotally coupled to the seat cushion. A first locking strut extends between one of the front legs and the recess within the floor and a second locking strut extends between the other of the front legs and the recess within the floor. First and second release handles are operatively coupled to the first and second locking struts, respectively, for independently unlocking the locking struts to selectively allow the riser mechanism to pivot the seat assembly from the seating position to the stowed position within the recess in the floor.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a seat assembly according to the invention;

FIG. 2 is a fragmentary, front perspective view of the seat assembly including a riser mechanism having front and rear legs;

FIG. 3 is a partial side view of the seat assembly including a first locking strut extending longitudinally between the front and rear legs;

FIG. 4 is an opposing, partial side view of the seat assembly including a second locking strut extending longitudinally between the front and rear legs; and

FIG. 5 is a fragmentary, perspective view of the riser mechanism including a rear leg and a second cable.

### DETAILED DESCRIPTION OF THE PREFERRED EMBODIMENT

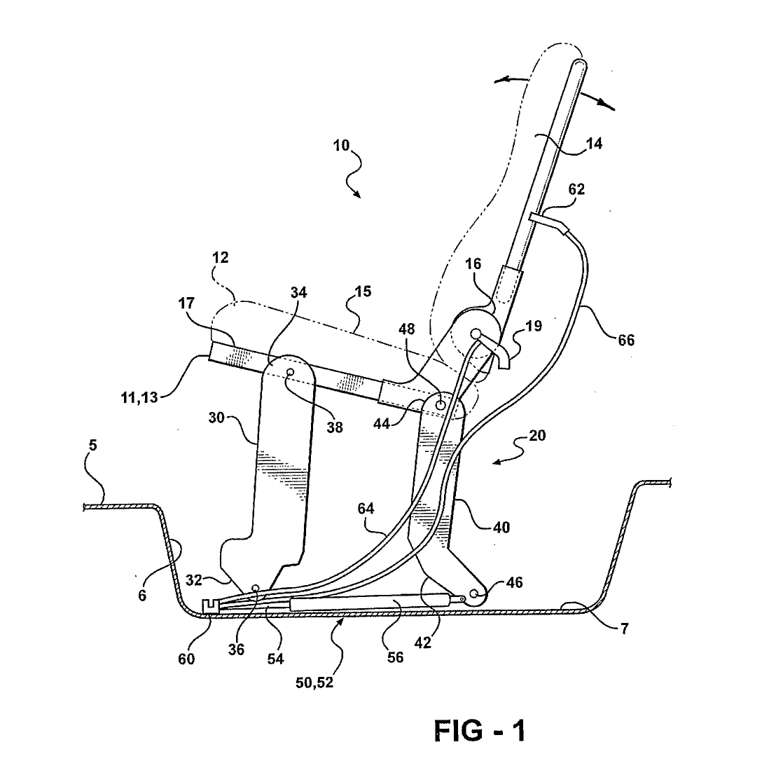

Referring to the FIG. 1, a seat assembly for an automotive vehicle is generally shown at 10. The seat assembly 10 includes a seat cushion 12 having a top seating surface 15 for supporting an occupant of the seat assembly 10 above a floor 5 in the vehicle and an opposite bottom surface 17. The floor 5 includes a recess 6 disposed therein including a recess bottom floor 7.

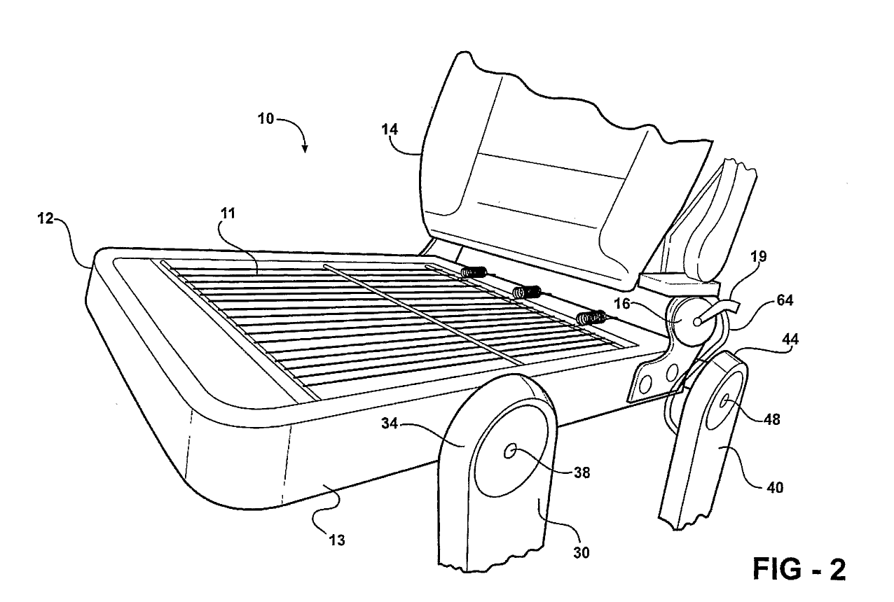

The seat cushion 12 extends between generally parallel and spaced apart side members 11, 13, shown in FIG. 2. Referring back to FIG. 1, a seat back 14 for supporting the back of the occupant is operatively coupled to the seat cushion 12 by a recliner mechanism 16 of any suitable type known to those skilled in the art. The recliner mechanism 16 can be actuated to a locked state or an unlocked state. In the unlocked state, the recliner mechanism 16 allows for selective pivotal adjustment of the seat back 14 relative to the seat cushion 12 between a generally upright plurality of reclined seating positions and a forwardly folded dump position overlying the seat cushion 12. In the locked state, the recliner mechanism 16 prevents pivotal movement of the seat back 14 relative to the seat cushion 12. The recliner mechanism 16 is biased toward the locked state. A first release handle 19 is coupled to the recliner mechanism 16 for actuating the recliner mechanism 16 between the locked and unlocked states.

A riser mechanism, generally shown at 20, extends between the bottom surface 17 of the seat cushion 12 and the recess bottom floor 7. The riser mechanism 20 allows selective movement of the seat assembly 10 between a seating position, in which the seat cushion 12 is spaced above the floor 5, and a stowed position, in which the seat cushion 12 is disposed within the recess 6 formed in the floor 5. The riser mechanism 20 includes a pair of generally parallel and spaced apart front legs 30. Each of the front legs 30 extends between a lower end 32 and an upper end 34. The lower end 32 of each of the front legs 30 is pivotally coupled by pivot pin 36 to the recess 6 immediately adjacent the recess bottom floor 7. The upper end 34 of each of the front legs 30 is pivotally coupled by pivot pin 38 to the side members 11, 13 of the seat cushion 12. The front legs 30 are joined laterally by a cross member 39 extending between the respective lower ends 32 thereof.

The riser mechanism 20 also includes a pair of generally parallel and spaced apart rear legs 40. Each of the rear legs 40 extends between a lower end 42 and an upper end 44. The lower end 42 of each rear leg 40 is pivotally coupled by pivot pin 46 to the recess 6 immediately adjacent the recess bottom floor 7. The upper end 44 of each rear leg 40 is pivotally coupled by pivot pin 48 to the side members 11, 13 of the seat cushion 12.

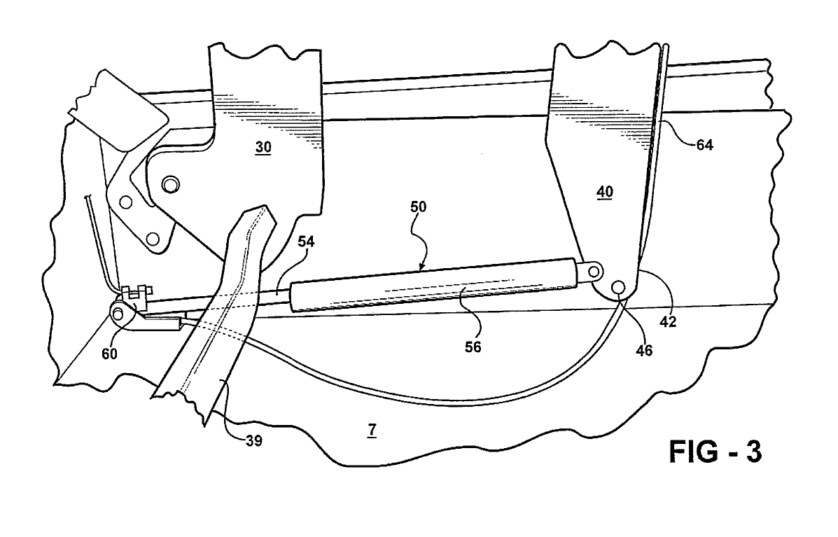

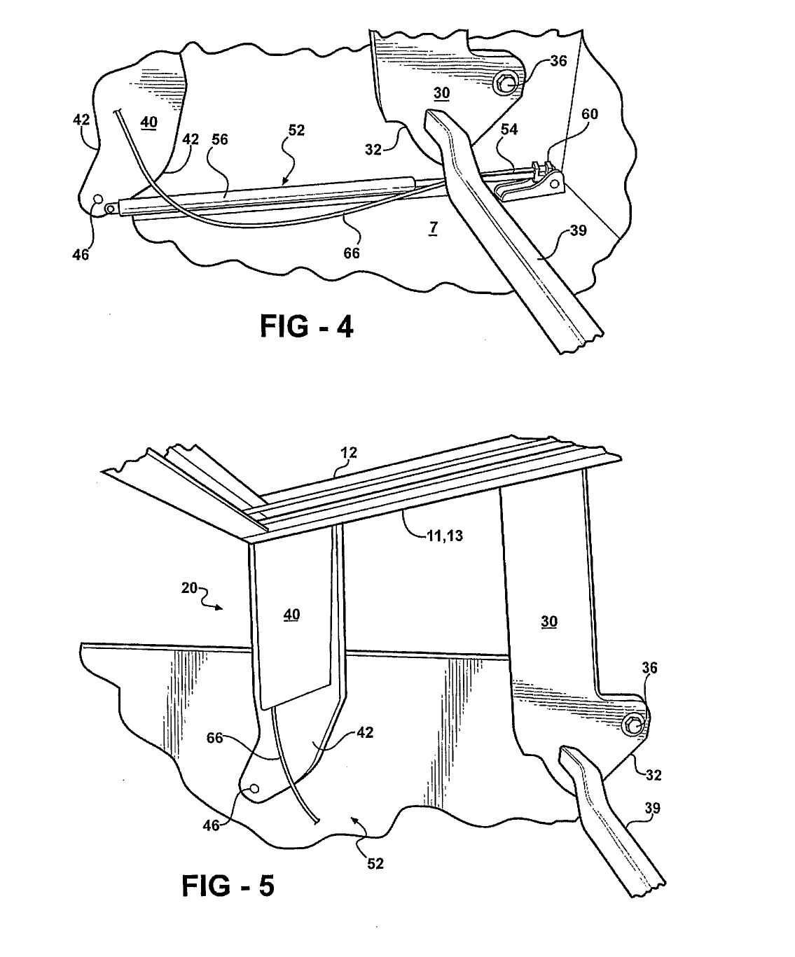

The seat assembly 10 also includes a pair of locking struts, generally indicated at 50, 52, for locking the seat assembly 10 in the seating position and releasing the seat assembly 10 for pivotal movement to the stowed position within the recess 6 in the floor 5. Each locking strut 50, 52 includes a elongated rod 54 slidably received within an elongated cylinder 56. A first locking strut 50, shown in FIG. 3, extends longitudinally between one of the front legs 30 and one of the rear legs 40. And a second locking strut 52, shown in FIG. 4, extends longitudinally between the other front leg 30 and the other rear leg 40. The end of each cylinder 56 is pivotally connected to the lower end 42 of the rear leg 40 and the end of each rod 54 is pivotally connected to the recess bottom floor 7 adjacent the front leg 30. Each locking strut 50, 52 further includes a locking mechanism 60 for locking and unlocking sliding movement of the rod 54 relative to the cylinder 56. With the locking mechanism 60 in the locked position, preventing sliding movement of the rod 54 relative to the cylinder 56, the locking struts 50, 52 prevent pivotal movement of the front and rear legs 30, 40 about the lower pivot pins 36, 46. The locking struts 50, 52 may be spring loaded, air, fluid, or gas pressurized to assist in supporting the weight of the seat assembly as the seat assembly is moved between the seating position and the stowed position.

The first release handle 19 facilitates actuation of one of the locking struts 50, 52 in addition to actuation of the recliner mechanism 16. A second release handle 62 is fixedly secured to the seat back 14 to facilitate independent actuation of the other locking strut 50, 52. A first cable 64 extends between the first release handle 19 and the locking mechanism 60 of one of the locking struts 50, 52. A second cable 66 extends between the second release handle 62 and the locking mechanism 60 of the other locking strut 50, 52.

In operation, the seat back 14 can be adjusted among the plurality of reclined seating positions by unlocking the recliner mechanism 16 via the first release handle 19. Releasing the handle 19 allows the recliner mechanism 16 to return to the locked state to lock the seat back 14 in the chosen one of the plurality of reclined seating positions. With the recliner mechanism 16 unlocked, the seat back 14 can also be moved between one of the plurality of reclined seating positions and the forwardly folded dump position. Additionally, actuation of the first release handle 19 pulls the first cable 64 to unlock the locking mechanism 60 of one of the locking struts 50, 52. The other locking strut 50, 52 remains locked to prevent movement of the seat assembly 10. With the seat back 14 in the forwardly folded dump position, actuation of the second release handle 62 pulls the second cable 66 to unlock the locking mechanism 60 of the other locking strut 50, 52. Each of the locking struts 50, 52 are now unlocked and the seat assembly 10 may be pivoted about the front and rear legs 30, 40. From the seating position, the seat assembly 10 may be pivoted forwardly about the legs 30, 40 to an easy entry position which allows additional space behind the seat assembly 10 for entry and exit within the vehicle. Alternatively, with each of the locking struts 50, 52 unlocked, the seat assembly 10 may be pivoted rearwardly and downwardly to the stowed position within the recess 6. The seat cushion 12 pivots about the upper ends 34, 44 of the front and rear legs 30, 40 to maintain the horizontal orientation of the seat cushion 12 relative to the floor 5. The lower ends 32, 42 of the front and rear legs 30, 40 pivot about the pivot pins 36, 46 in the recess 6 to lower the seat assembly 10 in its horizontal orientation into the recess 6 within the floor 5 for stowage therein. The seat back 14 is folded forwardly overlying the seat cushion 12 to provide a load floor flush with the floor 5 of the vehicle. Alternatively, the recess 6 may include closure doors coupled to the floor 5 for covering the seat assembly 10 once stowed and closing the recess 6 to provide a contiguous floor 5 within the vehicle.

The invention has been described in an illustrative manner, and it is to be understood that the terminology, which has been used, is intended to be in the nature of words of description rather than of limitation.

Many modifications and variations of the present invention are possible in light of the above teachings. It is, therefore, to be understood that within the scope of the appended claims, the invention can be practiced other than as specifically described.

### FIELD OF THE INVENTION

The present invention relates to a seat assembly for an automotive vehicle. More particularly, the invention relates to a riser mechanism for providing movement of the seat assembly between a seating position and a stowed position.

### DESCRIPTION OF THE RELATED ART

Automotive vehicles include seat assemblies for supporting occupants within the vehicle. Seat assemblies include a seat cushion and a seat back operatively coupled to the seat cushion by a recliner mechanism for allowing selective pivotal adjustment of the seat back relative to the seat cushion between a plurality of reclined seating positions. Typically, the seat back is also movable between any one of the reclined seating positions and a generally horizontal, forwardly stowed position to present a load floor surface on the back of the seat back.

It is known in the automotive seating art to mount a four bar linkage between the seat cushion and the floor of the vehicle for moving the seat assembly between a seating position with the seat cushion spaced above the floor of the vehicle and a forwardly stowed position with the seat cushion disposed generally forward of the seating position and lying against the floor of the vehicle. The four bar linkage, as currently practiced in the seating art, requires additional packaging space forward of the seat assembly. It remains desirable to have the seat assembly selectively recline between various seating position and optionally fold to the stowed position such that the load floor surface is generally planar with the cargo floor behind the seat assembly, or alternatively, with a load floor surface of a rear seat assembly similarly positioned.

### SUMMARY OF THE INVENTION

According to one aspect of the invention, a seat assembly supports an occupant above a floor of a vehicle and is stowable within a recess below the floor. The seat assembly includes a seat cushion extending between a top seating surface and a bottom surface. A seat back is pivotally coupled to the seat cushion for movement between a seating position and a forwardly folded dump position overlying the seat cushion. A riser mechanism extends between the bottom surface of the seat cushion and the recess for allowing selective movement of the seat assembly between a seating position to support the occupant above the floor and a stowed position disposed within the recess in the floor. The riser mechanism includes a pair of front legs having a lower end pivotally coupled to the recess within the floor and an upper end pivotally coupled to the seat cushion, and a pair of rear legs having a lower end pivotally coupled to the recess within the floor and an upper end pivotally coupled to the seat cushion. A first locking strut extends between one of the front legs and the recess within the floor and a second locking strut extends between the other of the front legs and the recess within the floor. First and second release handles are operatively coupled to the first and second locking struts, respectively, for independently unlocking the locking struts to selectively allow the riser mechanism to pivot the seat assembly from the seating position to the stowed position within the recess in the floor.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a seat assembly according to the invention;

FIG. 2 is a fragmentary, front perspective view of the seat assembly including a riser mechanism having front and rear legs;

FIG. 3 is a partial side view of the seat assembly including a first locking strut extending longitudinally between the front and rear legs;

FIG. 4 is an opposing, partial side view of the seat assembly including a second locking strut extending longitudinally between the front and rear legs; and

FIG. 5 is a fragmentary, perspective view of the riser mechanism including a rear leg and a second cable.

### DETAILED DESCRIPTION OF THE PREFERRED EMBODIMENT

Referring to the FIG. 1, a seat assembly for an automotive vehicle is generally shown at 10. The seat assembly 10 includes a seat cushion 12 having a top seating surface 15 for supporting an occupant of the seat assembly 10 above a floor 5 in the vehicle and an opposite bottom surface 17. The floor 5 includes a recess 6 disposed therein including a recess bottom floor 7.

The seat cushion 12 extends between generally parallel and spaced apart side members 11, 13, shown in FIG. 2. Referring back to FIG. 1, a seat back 14 for supporting the back of the occupant is operatively coupled to the seat cushion 12 by a recliner mechanism 16 of any suitable type known to those skilled in the art. The recliner mechanism 16 can be actuated to a locked state or an unlocked state. In the unlocked state, the recliner mechanism 16 allows for selective pivotal adjustment of the seat back 14 relative to the seat cushion 12 between a generally upright plurality of reclined seating positions and a forwardly folded dump position overlying the seat cushion 12. In the locked state, the recliner mechanism 16 prevents pivotal movement of the seat back 14 relative to the seat cushion 12. The recliner mechanism 16 is biased toward the locked state. A first release handle 19 is coupled to the recliner mechanism 16 for actuating the recliner mechanism 16 between the locked and unlocked states.

A riser mechanism, generally shown at 20, extends between the bottom surface 17 of the seat cushion 12 and the recess bottom floor 7. The riser mechanism 20 allows selective movement of the seat assembly 10 between a seating position, in which the seat cushion 12 is spaced above the floor 5, and a stowed position, in which the seat cushion 12 is disposed within the recess 6 formed in the floor 5. The riser mechanism 20 includes a pair of generally parallel and spaced apart front legs 30. Each of the front legs 30 extends between a lower end 32 and an upper end 34. The lower end 32 of each of the front legs 30 is pivotally coupled by pivot pin 36 to the recess 6 immediately adjacent the recess bottom floor 7. The upper end 34 of each of the front legs 30 is pivotally coupled by pivot pin 38 to the side members 11, 13 of the seat cushion 12. The front legs 30 are joined laterally by a cross member 39 extending between the respective lower ends 32 thereof.

The riser mechanism 20 also includes a pair of generally parallel and spaced apart rear legs 40. Each of the rear legs 40 extends between a lower end 42 and an upper end 44. The lower end 42 of each rear leg 40 is pivotally coupled by pivot pin 46 to the recess 6 immediately adjacent the recess bottom floor 7. The upper end 44 of each rear leg 40 is pivotally coupled by pivot pin 48 to the side members 11, 13 of the seat cushion 12.

The seat assembly 10 also includes a pair of locking struts, generally indicated at 50, 52, for locking the seat assembly 10 in the seating position and releasing the seat assembly 10 for pivotal movement to the stowed position within the recess 6 in the floor 5. Each locking strut 50, 52 includes a elongated rod 54 slidably received within an elongated cylinder 56. A first locking strut 50, shown in FIG. 3, extends longitudinally between one of the front legs 30 and one of the rear legs 40. And a second locking strut 52, shown in FIG. 4, extends longitudinally between the other front leg 30 and the other rear leg 40. The end of each cylinder 56 is pivotally connected to the lower end 42 of the rear leg 40 and the end of each rod 54 is pivotally connected to the recess bottom floor 7 adjacent the front leg 30. Each locking strut 50, 52 further includes a locking mechanism 60 for locking and unlocking sliding movement of the rod 54 relative to the cylinder 56. With the locking mechanism 60 in the locked position, preventing sliding movement of the rod 54 relative to the cylinder 56, the locking struts 50, 52 prevent pivotal movement of the front and rear legs 30, 40 about the lower pivot pins 36, 46. The locking struts 50, 52 may be spring loaded, air, fluid, or gas pressurized to assist in supporting the weight of the seat assembly as the seat assembly is moved between the seating position and the stowed position.

The first release handle 19 facilitates actuation of one of the locking struts 50, 52 in addition to actuation of the recliner mechanism 16. A second release handle 62 is fixedly secured to the seat back 14 to facilitate independent actuation of the other locking strut 50, 52. A first cable 64 extends between the first release handle 19 and the locking mechanism 60 of one of the locking struts 50, 52. A second cable 66 extends between the second release handle 62 and the locking mechanism 60 of the other locking strut 50, 52.

In operation, the seat back 14 can be adjusted among the plurality of reclined seating positions by unlocking the recliner mechanism 16 via the first release handle 19. Releasing the handle 19 allows the recliner mechanism 16 to return to the locked state to lock the seat back 14 in the chosen one of the plurality of reclined seating positions. With the recliner mechanism 16 unlocked, the seat back 14 can also be moved between one of the plurality of reclined seating positions and the forwardly folded dump position. Additionally, actuation of the first release handle 19 pulls the first cable 64 to unlock the locking mechanism 60 of one of the locking struts 50, 52. The other locking strut 50, 52 remains locked to prevent movement of the seat assembly 10. With the seat back 14 in the forwardly folded dump position, actuation of the second release handle 62 pulls the second cable 66 to unlock the locking mechanism 60 of the other locking strut 50, 52. Each of the locking struts 50, 52 are now unlocked and the seat assembly 10 may be pivoted about the front and rear legs 30, 40. From the seating position, the seat assembly 10 may be pivoted forwardly about the legs 30, 40 to an easy entry position which allows additional space behind the seat assembly 10 for entry and exit within the vehicle. Alternatively, with each of the locking struts 50, 52 unlocked, the seat assembly 10 may be pivoted rearwardly and downwardly to the stowed position within the recess 6. The seat cushion 12 pivots about the upper ends 34, 44 of the front and rear legs 30, 40 to maintain the horizontal orientation of the seat cushion 12 relative to the floor 5. The lower ends 32, 42 of the front and rear legs 30, 40 pivot about the pivot pins 36, 46 in the recess 6 to lower the seat assembly 10 in its horizontal orientation into the recess 6 within the floor 5 for stowage therein. The seat back 14 is folded forwardly overlying the seat cushion 12 to provide a load floor flush with the floor 5 of the vehicle. Alternatively, the recess 6 may include closure doors coupled to the floor 5 for covering the seat assembly 10 once stowed and closing the recess 6 to provide a contiguous floor 5 within the vehicle.

The invention has been described in an illustrative manner, and it is to be understood that the terminology, which has been used, is intended to be in the nature of words of description rather than of limitation.

Many modifications and variations of the present invention are possible in light of the above teachings. It is, therefore, to be understood that within the scope of the appended claims, the invention can be practiced other than as specifically described.

What is claimed:

1. A seat assembly for supporting an occupant above a floor of a vehicle and stowable within a recess below the floor, said seat assembly comprising:
a seat cushion extending between a top seating surface and a bottom surface;
a seat back pivotally coupled to said seat cushion for movement between a seating position and a forwardly folded dump position overlying said seat cushion;
a riser mechanism extending between said bottom surface of said seat cushion and the recess for allowing selective movement of said seat assembly between a seating position to support the occupant above the floor and a stowed position disposed within the recess in the floor, said riser mechanism including a pair of front legs having a lower end pivotally coupled to the recess within the floor and an upper end pivotally coupled to said seat cushion and a pair of rear legs having a lower end pivotally coupled to the recess within the floor and an upper end pivotally coupled to said seat cushion;
a first locking strut extending between one of said front legs and the recess within the floor;
a second locking strut extending between said other of said front legs and the recess within the floor; and
first and second release handles operatively coupled to said first and second locking struts, respectively, for independently unlocking said locking struts to selectively allow said riser mechanism to pivot said seat assembly from said seating position to said stowed position within the recess in the floor.

2. A seat assembly as set forth in claim 1 further including a recliner mechanism operatively coupled between said seat back and said seat cushion for selectively unlocking said seat back and allowing pivotal movement relative to said seat cushion between a plurality of reclined seating positions and said forwardly folded dump position overlying said seat cushion.

3. A seat assembly as set forth in claim 2 wherein said first release handle is operatively coupled to both said recliner mechanism and said first locking strut for selectively actuating and unlocking said recliner mechanism to allow said pivotal movement of said seat back between said plurality of reclined seating positions and said forwardly folded dump position and simultaneously unlocking said first locking strut.

4. A seat assembly as set forth in claim 3 wherein each of said first and second locking struts include an elongated rod slidably received within an elongated cylinder for longitudinal sliding movement therein.

5. A seat assembly as set forth in claim 4 wherein each of said first and second locking struts include a locking mechanism operatively coupled between said rod and said cylinder for selectively locking and unlocking said strut to allow said longitudinal sliding movement between said rod and cylinder.

6. A seat assembly as set forth in claim 5 wherein said cylinder of said first locking strut is coupled to said lower end of one of said rear legs and said rod in fixedly secured to the recess within the floor adjacent said lower end of one of said front legs.

7. A seat assembly as set forth in claim 6 wherein said second locking strut is spaced apart and parallel to said first locking strut, said cylinder of said second locking strut is coupled to said lower end of said other rear leg and said rod is fixedly secured to the recess within the floor adjacent said lower end of said other front leg.

8. A seat assembly as set forth in claim 7 further including a first cable coupled between said first release handle and said locking mechanism of said first locking strut for actuating said locking mechanism between said locked and unlocked states in response to actuation of said first release handle.

9. A seat assembly as set forth in claim 8 further including a second cable coupled between said second release handle and said locking mechanism of said second locking strut for independently actuating said locking mechanism between said locked and unlocked states in response to actuation of said second release handle.

10. A seat assembly as set forth in claim 9 wherein said seat cushion includes laterally spaced apart side members, and wherein said upper ends of said front legs are pivotally coupled to said respective side members and said upper ends of said rear legs are pivotally coupled to said respective side members and spaced rearward of said front legs.
